(19) United States
(12) Patent Application Publication
(10) Pub. No.: US 2018/0217325 A1
(43) Pub. Date: Aug. 2, 2018

(54) BEND-RESISTANT MINI OPTICAL FIBER AND MANUFACTURING METHOD THEREOF

(71) Applicant: ZHONGTIAN TECHNOLOGY FIBRE OPTICS CO., LTD, Nantong (CN)

(72) Inventors: Shanshan CAO, Nantong (CN); Zhizhong LIU, Nantong (CN); Jigang HU, Nantong (CN); Zhen WANG, Nantong (CN); Haitao ZHANG, Nantong (CN); Hui ZHOU, Nantong (CN)

(73) Assignee: ZHONGTIAN TECHNOLOGY FIBRE OPTICS CO., LTD, Nantong (CN)

(21) Appl. No.: 15/756,578

(22) PCT Filed: Dec. 29, 2015
(86) PCT No.: PCT/CN2015/099425

§ 371 Date: Feb. 28, 2018

(30) Foreign Application Priority Data
Aug. 31, 2015 (CN) 201510542224.X

(51) Int. Cl. G02B 6/036; G02B 6/02

(52) U.S. Cl. CPC G02B 6/03638; G02B 6/02004; G02B 6/02395

(57) ABSTRACT

A bend-resistant mini optical fiber and manufacturing method thereof, first, preparing a preform via a modified chemical vapor deposition process, and manufacturing an optical fiber via drawing at a certain temperature. The advantageous of the present invention are as following, the bend-resistant mini optical fiber is primarily formed by a core layer, a platform layer, a depression layer, an outer cladding layer and a coating layer, and the relative refractive index and radius of each of the layers is reasonably controlled; and a cutoff wavelength is effectively controlled by employing an automatic temperature and tension monitoring procedure during the drawing process, such that the cutoff wavelength and a mode field diameter are maintained in a relatively stable range, and the cutoff wavelength is adjusted upward while the mode field diameter remains stable, thus facilitating a decrease of bend loss of the optical fiber.

### CROSS REFERENCE TO RELATED APPLICATIONS

This application is the national phase entry of International Application No. PCT/CN2015/099425, filed on Dec. 29, 2015, which is based upon and claims priority to Chinese Application No.201510542224.X, filed on Aug. 31, 2015, the entire contents of which are incorporated herein by reference.

### TECHNICAL FIELD

The present invention relates to a bend-resistant mini optical fiber and manufacturing method thereof, belonging to a field of optical fiber transmission technology.

### BACKGROUND

With China's large-scale promotion of Triple Play and Broadband China strategy, will come a new round of growth of the construction of 4G networks and data centers. With the expansion of broadband services, the construction of communication networks has developed from core networks to access networks and FTTH (fiber to the home, FTTH). The optical fibers built by FTTH are located in crowded and narrow channels and are repeatedly bent and placed on the connected line terminals, requiring higher standards for the bending loss of the optical fiber.

Fiber optic devices are indispensable devices in optical fiber communication systems and optical fiber sensing systems. The traditional single-mode optical fiber cladding has a diameter of 125 um and an outer diameter of 245 um after coating. The traditional single-mode optical fiber can not meet the space requirements of some devices and has a relatively large blending loss. Therefore, it is urgently necessary to develop a narrow-diameter bend-resistant optical fiber with reduced space resource and ultra-low bending loss performance and a manufacturing method thereof, and at the same time, in the manufacturing of optical fiber, the cutoff wavelength needs to be effectively controlled. When the cutoff wavelength is larger, the macrobending loss of the optical fiber is smaller.

### SUMMARY OF THE INVENTION

The technical problem to be solved by the present invention is to provide a narrow-diameter bending resistant optical fiber with reduced space resources and ultra-low bending loss performance and a manufacturing method thereof.

In order to solve the above technical problem, the technical solution of the present invention is as follows: a bend-resistant mini optical fiber, the innovation of which is that the mini optical fiber includes (from inside to outside) a core layer, a platform layer, a depression layer, an outer cladding layer and a coating layer which are sequentially arranged. The refractive index of the core layer, the platform layer and the depression layer decreases sequentially. The relative refractive index of the core layer is 0.06 to 0.28% and the radius is 2.5 to 3.5 um; the relative refractive index of the platform layer is −0.38 to −0.15%, the radius is 16 to 27 um; the relative refractive index of the depression layer is −0.7 to −0.15% and the radius is 30 to 45 um; and the cladding layer is a pure silica glass layer with a diameter of 80±1 um.

Further, the diameter of the bend-resistant mini optical fiber is 10 mm, and in the case that winding the bend-resistant mini optical fiber around 100 turns or more, the bend loss of the narrow-diameter bending-resistant fiber is less than 0.05 dB at 1550 nm.

Further, the coating layer has a diameter of 155-170 um.

The present invention is based on a narrow-diameter bend-resistant optical fiber, discloses a manufacturing method of a narrow-diameter bend-resistant optical fiber, the innovation point is that: the manufacturing method is as follows:

(1) The outer cladding layer, the depression layer, the platform layer and the core layer are successively deposited by a modified chemical vapor deposition method;

(2) The deposited tube is placed on a heat shrinking machine and fused and shrank into a solid preform;

(3) The preform is fixed on the drawing tower and drawn into optical fiber at a temperature of 2150° C.;

(4) Installing the coating mold for drawing, cutting the optical fiber after drawing;

(5) Setting the curing distance of drawing tower as 2 m-4 m, and curing and drying the optical fiber in the curing oven;

(6) After curing, the optical fiber is wound on an automatic wire take-up device, and the optical fiber drawing cone is designed. The angle of the V-shaped cone is controlled at 20 to 50 degrees to facilitate the positioning of the mini diameter optical fiber.

(7) Setting up the calculation model, and calculating the service life of the optical fiber according to the elastic modulus of the optical fiber, the force application time and the bending coefficient.

Further, the coating pressure at the drawing in the step (4) is 0.02 to 0.025 MPa and the drawing speed is 800 to 1500 m/min.

Further, the total power of the curing oven in the step (5) is 18000-24000W.

The advantages of the present invention are as below:

(1) A bend-resistant mini optical fiber is primarily formed by a core layer, a platform layer, a depression layer, an outer cladding layer and a coating layer, and the relative refractive index and radius of each of the layers is reasonably controlled; and a cutoff wavelength is effectively controlled by employing an automatic temperature and tension monitoring procedure during the drawing process, such that the cutoff wavelength and a mode field diameter are maintained in a relatively stable range, and the cutoff wavelength is adjusted upward while the mode field diameter remains stable, thus facilitating a decrease of macrobending loss of the optical fiber.

(2) The bend loss of the bend-resistant mini optical fiber at 1550 nm is less than 0.05 dB when the diameter of bend-resistant mini optical fiber is 10 mm, and in case of winding the bend-resistant mini optical fiber around 100 turns or more, which is beneficial to the FTTH construction and development of the small optical fiber devices in the country.

(3) The diameter of bend-resistant mini optical fiber is only 80 um, the coating is less than 170 um, compared to the conventional optical fiber with a diameter of 125/245 um, the present invention effectively saves resources. Compared with the traditional optical fiber, the new optical fiber can meet the screening strain above 2%, with higher strength.

(4) After the preparation of the bend-resistant mini optical fiber is completed, the calculation model is set up to effectively calculate the service life of the optical fiber according to the elastic modulus of the optical fiber, the force application time and the bending coefficient. Generally, the bend-resistant mini optical fiber of the present invention meets the service life of more than 30 years.

(5) In the optical fiber manufacturing process, the coating pressure is 0.02-0.025 MPa, the drawing speed is 800-1500 m/min, so that the optical fiber has stable buffer coating and protective coating, and ensures good optical fiber quality.

(6) The total power of the curing oven is 18000-24000W, curing and drying is quick and the product quality is good.

### BRIEF DESCRIPTION OF THE DRAWINGS

FIG. 1 is a distribution map of the refractive index profile structure of the bend-resistant mini optical fiber of the present invention.

### DETAILED DESCRIPTION OF THE INVENTION

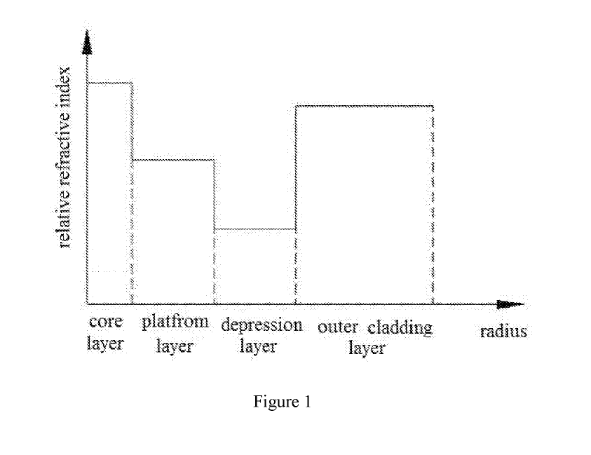

As shown in FIG. 1, a bend-resistant mini optical fiber, includes a core layer, a platform layer, a depression layer, an outer cladding layer and a coating layer which are sequentially arranged from inside to outside; the refractive index of the core layer, the platform layer and the depression layer decreases sequentially; the relative refractive index of the core layer is 0.06 to 0.28% and the radius is 2.5 to 3.5 um; the relative refractive index of the platform layer is −0.38 to −0.15%, the radius is 16 to 27 um; the relative refractive index of the depression layer is −0.7 to −0.15% and the radius is 30 to 45 um; and the outer cladding layer is pure silica glass layer with diameter of 80±1 um.

### Embodiment 1

The present invention further discloses a manufacturing method of a bend-resistant mini optical fiber, the manufacturing method is as follows:

(1) The outer cladding layer, the depression layer, the platform layer and the core layer are successively deposited by modified chemical vapor deposition method;

(2) The deposited tube is placed on heat shrinking machine and fused and shrank into solid preform;

(3) The preform is fixed on the drawing tower and drawn into optical fiber at a temperature of 2150° C.;

(4) Installing the coating mold for drawing, the coating pressure is controlled between 0.01-0.02 Mpa, the drawing speed is 500-800 m/min, cutting the optical fiber after drawing;

(5) Setting the curing distance of drawing tower as 2 m -4 m, and curing and drying the optical fiber in curing oven; the total power of the curing oven is 18000-24000W.

(6) After curing, the optical fiber is wound on an automatic wire take-up device, and the optical fiber drawing cone is designed. The angle of the V-shaped cone is controlled at 20 to 50 degrees to facilitate the positioning of the mini diameter optical fiber.

(7) Setting up the calculation model, and calculating the service life of the optical fiber according to the elastic modulus of the optical fiber, the force application time and the bending coefficient.

The table shown below is: Table of the relationship between coating pressure and drawing speed on the number of times of fiber breakages

### Embodiment 2

A manufacturing method of a bend-resistant mini optical fiber is shown as below:

(1) The outer cladding layer, the depression layer, the platform layer and the core layer are successively deposited by modified chemical vapor deposition method;

(2) The deposited tube is placed on heat shrinking machine and fused and shrank into solid preform;

(3) The preform is fixed on the drawing tower and drawn into optical fiber at a temperature of 2150° C.;

(4) Installing the coating mold for drawing, wherein the coating pressure is controlled between 0.02-0.025 Mpa, the drawing speed is 800-1500 m/min, cutting the optical fiber after drawing;

(5) Setting the curing distance of drawing tower as 2 m -4 m, and curing and drying the optical fiber in curing oven; wherein the total power of the curing oven is 18000-24000W.

(6) After curing, the optical fiber is wound on an automatic wire take-up device, and the optical fiber drawing cone is designed. The angle of the V-shaped cone is controlled at 20 to 50 degrees to facilitate the positioning of the mini diameter optical fiber.

(7) Setting up the calculation model, and calculating the service life of the optical fiber according to the elastic modulus of the optical fiber, the force application time and the bending coefficient.

The table shown below is: Table of the relationship between coating pressure and drawing speed on the number of times of fiber breakages

### Embodiment 3

A manufacturing method of a bend-resistant mini optical fiber is shown as below:

(1) The outer cladding layer, the depression layer, the platform layer and the core layer are successively deposited by modified chemical vapor deposition method;

(2) The deposited tube is placed on a heat shrinking machine and fused and shrank into solid preform;

(3) The preform is fixed on the drawing tower and drawn into optical fiber at a temperature of 2150° C.;

(4) Installing the coating mold for drawing, wherein the coating pressure is controlled between 0.025-0.035 Mpa, the drawing speed is 1500-2000m/min, cutting the optical fiber after drawing;

(5) Setting the curing distance of drawing tower as 2 m -4 m, and curing and drying the optical fiber in curing oven; wherein the total power of the curing oven is 18000-24000W.

(6) After curing, the optical fiber is wound on an automatic wire take-up device, and the optical fiber drawing cone is designed. The angle of the V-shaped cone is controlled at 20 to 50 degrees to facilitate the positioning of the mini diameter optical fiber.

(7) Setting up the calculation model, and calculating the service life of the optical fiber according to the elastic modulus of the optical fiber, the force application time and the bending coefficient.

The table shown below is: Table of the relationship between coating pressure and drawing speed on the number of times of fiber breakages

According to the above embodiments, the optical fiber in Embodiment 2 has the least number of breakages in the drawing process, and at this time, the structure is the most stable and has the best quality. Therefore, the coating pressure of 0.02 to 0.025 MPa and the drawing speed of 800 to 1500 m/min are selected.

The basic principles and main features of the present invention have been shown and described above. It should be understood by those skilled in the art that the present invention is not limited to the above embodiments, and the above embodiments and description only illustrate the principle of the present invention.

Without departing from the spirit and scope of the present invention, the present invention also has various changes and modifications which fall within the scope of the claimed invention. The scope of protection demanded by the present invention is defined by the appended claims and their equivalents.

What is claimed is:

1. A bend-resistant mini optical fiber, comprising a core layer, a platform layer, a depression layer, an outer cladding layer and a coating layer which are sequentially arranged from inside to outside; a refractive index of the core layer, a refractive index of the platform layer and a refractive index of the depression layer reduces sequentially; the relative refractive index of the core layer is 0.06 to 0.28% and a radius of the core layer is 2.5 to 3.5 um; the relative refractive index of the platform layer is −0.38 to −0.15%, a radius of the platform layer is 16 to 27 um; the relative refractive index of the depression layer is −0.7 to −0.15% and a radius of depression layer is 30 to 45 um; and the outer cladding layer is a pure silica glass layer with a diameter of 80±1 um.

2. The bend-resistant mini optical fiber according to claim 1, wherein when the diameter of the bend-resistant mini optical fiber is 10 mm and in case of winding the bend-resistant mini optical fiber around 100 turns or more, the bend loss of the bend-resistant mini optical fiber is less than 0.05 dB at 1550 nm.

3. The bend-resistant mini optical fiber according to claim 1, wherein a diameter of the coating layer is 155-170 um.

4. A manufacturing method of the bend-resistant mini optical fiber, the bend-resistant mini optical fiber comprises a core layer, a platform layer, a depression layer, an outer cladding layer and a coating layer which are sequentially arranged from inside to outside; a refractive index of the core layer, a refractive index of the platform layer and a refractive index of the depression layer reduces sequentially; the relative refractive index of the core layer is 0.06 to 0.28% and a radius of the core layer is 2.5 to 3.5 um; the relative refractive index of the platform layer is −0.38 to −0.15%, a radius of the platform layer is 16 to 27 μm um; the relative refractive index of the depression layer is −0.7 to −0.15% and a radius of depression layer is 30 to 45 um; and the outer cladding layer is a pure silica glass layer with a diameter of 80±1 um;
wherein the manufacturing method of the bend-resistant mini optical fiber comprises:
(1) successively depositing the outer cladding layer, the depression layer, the platform layer and the core layer by a modified chemical vapor deposition method;
(2) placing a deposited tube on a heat shrinking machine and fusing and shrinking the deposited tube into a solid preform;
(3) fixing the preform on a drawing tower and drawn into an optical fiber at a temperature of 2150° C.;
(4) installing a coating mold for drawing, cutting the optical fiber after drawing;
(5) setting a curing distance of drawing tower as 2 m -4 m, and curing and drying the optical fiber in a curing oven;
(6) after curing, winding the optical fiber on an automatic wire take-up device, designing the optical fiber drawing cone; wherein an angle of a V-shaped cone is controlled at 20 to 50 degrees to facilitate the positioning of the mini diameter optical fiber;
(7) setting up a calculation model, and calculating the service life of the optical fiber according to elastic modulus of the optical fiber, force application time and bending coefficient.

5. The manufacturing method of the bend-resistant mini optical fiber according to claim 4, wherein a coating pressure at the drawing in the step (4) is 0.02 to 0.025 MPa and a drawing speed is 800 to 1500 m/min.

6. The manufacturing method of the bend-resistant mini optical fiber according to claim 4, wherein a total power of the curing oven in the step (5) is 18000-24000W.
